(19) United States
(12) Patent Application Publication
(10) Pub. No.: US 2025/0199736 A1
(43) Pub. Date: Jun. 19, 2025

(54) INFORMATION PROCESSING APPARATUS, INFORMATION PROCESSING SYSTEM, INFORMATION PROCESSING METHOD, IMAGE FORMING SYSTEM, IMAGE FORMING METHOD, AND STORAGE MEDIUM

(71) Applicant: Konica Minolta, Inc., Tokyo (JP)

(72) Inventor: Naoto KUBO, Tokyo (JP)

(21) Appl. No.: 18/977,410

(22) Filed: Dec. 11, 2024

(30) Foreign Application Priority Data
Dec. 15, 2023 (JP) 2023-211938

(51) Int. Cl. G06F 3/12

(52) U.S. Cl. CPC G06F 3/1257; G06F 3/1204; G06F 3/1208

(57) ABSTRACT

Provided is an image processing apparatus including: an association storage section that stores a sheet profile and identification information for identifying a tray to accommodate sheets in association with each other; and a hardware processor. The hardware processor accepts selection of at least one of the sheet profile and the identification information, and registers the at least one of the sheet profile and the identification information that is accepted in association with the tray.

### CROSS-REFERENCE TO RELATED APPLICATIONS

This application is based upon and claims the benefit of priority from the prior Japanese Patent Application No. 2023-211938, filed on Dec. 15, 2023, the entire contents of which are incorporated herein by reference.

### BACKGROUND OF THE INVENTION

### Technical Field

The present invention relates to an information processing apparatus, an information processing system, an information processing method, an information processing program, an image forming system, an image forming method, and an image forming program.

### Background Art

Production printing requires a higher level of quality than office printing. For this reason, in production printing, printing conditions are finely set for each sheet, thereby coping with the diversification of sheet types without degrading the printing quality. Since appropriate printing conditions differ for each sheet, it may take several hours even for a skilled operator to narrow down the settings suitable for a sheet. Therefore, it is very inefficient to set the printing conditions every time printing is performed.

Therefore, a technique has been proposed in which printing conditions narrowed down by a user are saved as a sheet profile in an image forming apparatus and are loaded as needed (see Japanese Unexamined Patent Publication No. 2011-113146). According to this technique, it is possible to reuse the printing conditions once narrowed down for the sheet, and efficiency is improved in setting the printing conditions.

### SUMMARY OF THE INVENTION

However, the ideal printing conditions differ depending on the tray in which the sheets are stored. For example, in a case where there are three sheet feed trays, ideal sheet feed conditions are different between the uppermost tray and the lowermost tray due to a difference in conveyance path or the like. Therefore, in a case where an inexperienced operator loads and sets printing conditions narrowed down for sheets to be supplied from a specific tray by a skilled operator for a different tray, expected quality might not be obtained, resulting in reprinting.

The present invention has been made in consideration of the above-described problems in the related art, and an object thereof is to make it possible to reuse sheet profiles set for each of sheet trays.

To achieve at least one of the abovementioned objects, according to an aspect of the present disclosure, provided is an image processing apparatus including:
an association storage section that stores a sheet profile and identification information for identifying a tray to accommodate sheets in association with each other; and
a hardware processor, wherein the hardware processor:
accepts selection of at least one of the sheet profile and the identification information; and
registers the at least one of the sheet profile and the identification information that is accepted in association with the tray.

To achieve at least one of the abovementioned objects, according to another aspect of the present disclosure, provided is an information processing apparatus including:
an association storage section that stores first information in which a sheet profile and identification information for identifying a tray to accommodate sheets in association with each other; and
a hardware processor, wherein the hardware processor:
accepts selection of the first information stored in the association storage section; and
registers the tray corresponding to the sheet profile included in the first information in association with the sheet profile included in the first information, the first information being accepted by the hardware processor.

To achieve at least one of the abovementioned objects, according to another aspect of the present disclosure, provided is an information processing system including:
an association storage section that stores a sheet profile and identification information for identifying a tray to accommodate sheets in association with each other; and
a hardware processor, wherein the hardware processor:
accepts selection of at least one of the sheet profile and the identification information; and
registers at least one of the sheet profile and the identification information that is accepted in association with the tray.

To achieve at least one of the abovementioned objects, according to another aspect of the present disclosure, provided is an information processing method including:
storing a sheet profile and identification information for identifying a tray to accommodate sheets in association with each other;
accepting selection of at least one of the sheet profile and the identification information; and
registering the at least one of the sheet profile and the identification information that is accepted in association with the tray.

To achieve at least one of the abovementioned objects, according to another aspect of the present disclosure, provided is an image forming method in an image forming apparatus including an image forming section that forms an image on a sheet, the method comprising:
storing in an association storage section a sheet profile and identification information for identifying a tray to accommodate sheets in association with each other; and
accepting selection of at least one of the sheet profile and the identification information; and
registering the at least one of the sheet profile and the identification information that is accepted in association with the tray.

According to the present invention, a sheet profile set for a tray can be reused.

### BRIEF DESCRIPTION OF THE DRAWINGS

The accompanying drawings are not intended as a definition of the limits of the invention but illustrate embodiments of the invention, and together with the general description given above and the detailed description of the embodiments given below, serve to explain the principles of the invention, wherein:

FIG. 1 is a system configuration diagram of an image forming system in a first embodiment of the present invention;

FIG. 2 is a diagram showing a configuration example of a sheet feed section of a image forming apparatus;

FIG. 3 is a flowchart showing profile registration processing;

FIG. 4A is an example of a tray setting status table;

FIG. 4B is an example of a profile registration table;

FIG. 5 is a flowchart showing profile calling processing.

FIG. 6 is an example of a recommended tray notification screen displayed on the image forming apparatus;

FIG. 7 is a flowchart showing batch registration processing upon job completion according to a second embodiment of the present invention;

FIG. 8A is an example of a tray setting status table;

FIG. 8B is an example of a parent profile registration table;

FIG. 8C is an example of a job history table;

FIG. 9 is an example of a collective registration confirmation screen displayed on the image forming apparatus;

FIG. 10 is an example of a parent profile name input screen displayed on the image forming apparatus;

FIG. 11 is a flowchart showing manual collective registration processing;

FIG. 12 is an example of a sheet setting screen displayed on the image forming apparatus;

FIG. 13 is a flowchart showing automatic loading processing.

FIG. 14 is an example of a sheet replacement instruction screen displayed on the image forming apparatus;

FIG. 15 is a ladder chart showing processing of manual loading from the controller apparatus;

FIG. 16 is an example of a tray setting screen displayed on the controller apparatus;

FIG. 17 is an example of a parent profile list screen displayed on the controller apparatus;

FIG. 18 is a flowchart showing manual loading processing from the main body screen;

FIG. 19 is an example of a parent profile list screen displayed on the image forming apparatus; and

FIG. 20 is an example of a parent profile registration table in a modification example 2.

### DESCRIPTION OF EMBODIMENTS

Hereinafter, one or more embodiments of the present invention will be described with reference to the drawings. However, the scope of the present invention is not limited to the disclosed embodiments.

### First Embodiment

First, a first embodiment of the present invention will be described.

### (Configuration of Image Forming System)

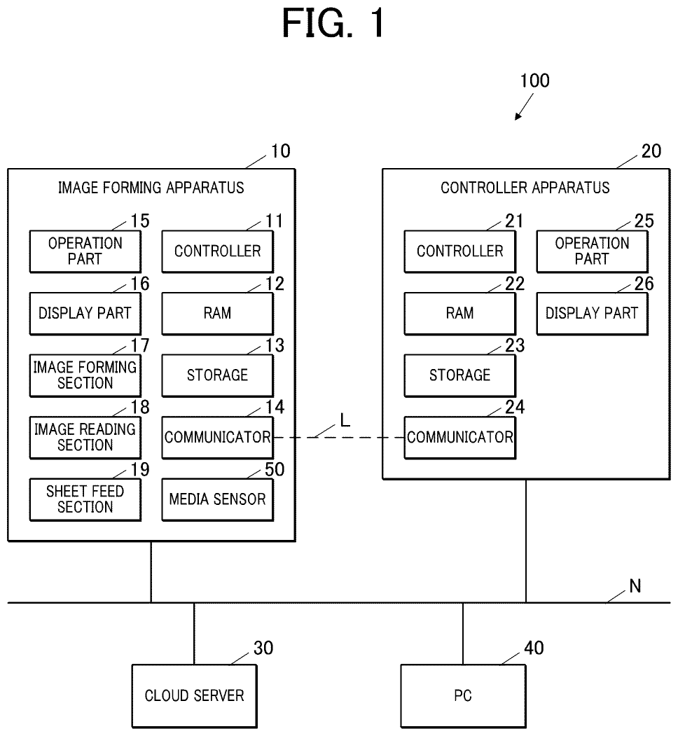

FIG. 1 is a system configuration diagram of an image forming system 100 (information processing system) in a first embodiment. As shown in FIG. 1, the image forming system 100 includes an image forming apparatus 10 (information processing apparatus), a controller apparatus 20, a cloud server 30, and a personal computer (PC) 40. Each apparatus constituting the image forming system 100 is connected to a local area network (LAN), and is connected via a communication network N such as the Internet.

The image forming apparatus 10 and the controller apparatus 20 are connected to each other via a dedicated line L for transmitting and receiving data.

The image forming apparatus 10 forms an image on a sheet based on image data. For example, the image forming apparatus 10 executes a copy job, a print job, or the like.

The controller apparatus 20 receives print data prepared by various kinds of application software from the PC 40 or the like. The controller apparatus 20 performs raster image processor (RIP) processing on the print data to convert the print data into raster data. The controller apparatus 20 outputs the raster data to the image forming apparatus 10.

The cloud server 30 is a server provided in a cloud environment. The cloud server 30 stores data and the like generated by the image forming apparatus 10.

The PC 40 executes various applications for creating print data. The PC 40 executes a program for outputting print data such as a printer driver. The PC 40 receives, based on a user operation, settings for a print job to be executed on the image forming apparatus 10 and outputs the print data to the controller apparatus 20.

### (Configuration of Image Forming Apparatus)

As shown in FIG. 1, the image forming apparatus 10 includes a controller 11, a random access memory (RAM) 12, a storage 13, a communicator 14, an operation part 15, a display part 16, an image forming section 17, an image reading section 18, a sheet feed section 19, and a media sensor 50.

The controller 11 includes a central processing unit (CPU). The controller 11 reads various programs stored in the storage 13, develops the programs in the RAM 12, and performs various kinds of processing in cooperation with the programs.

The RAM 12 temporarily stores various programs, various kinds of date, parameters, and the like read from the storage 13 in various kinds of processing executed by the controller 11.

The storage 13 is a storage device including a hard disk, a nonvolatile semiconductor memory, or the like. For example, various programs and parameters and data necessary for executing the various programs are stored in the storage 13. Further, the storage 13 stores data generated in various kinds of processing.

The communicator 14 transmits and receives data to and from an external device connected via the communication network N or the dedicated line L.

The operation part 15 receives an operation command from a user. The operation part 15 includes numeric input keys, various function keys, a touch screen stacked on the display part 16, and the like. The operation part 15 outputs an operation signal corresponding to each key to the controller 11. The operation part 15 outputs an operation signal corresponding to a position of a touch operation on the touch screen to the controller 11.

The display part 16 includes a liquid crystal display (LCD) or the like. The display part 16 displays various screens according to a command of a display signal from the controller 11.

The image forming section 17 forms a color image on a sheet based on image data corresponding to each color of yellow, magenta, cyan, and black by, for example, an electrophotographic method. The image data may be image data obtained by reading an image from a document, or may be image data received from an external apparatus.

The image reading section 18 includes an automatic document feeder (ADF) and a scanner. The image reading section 18 outputs image data obtained by reading an image of a document to the controller 11.

The sheet feed section 19 supplies a sheet to the image forming section 17.

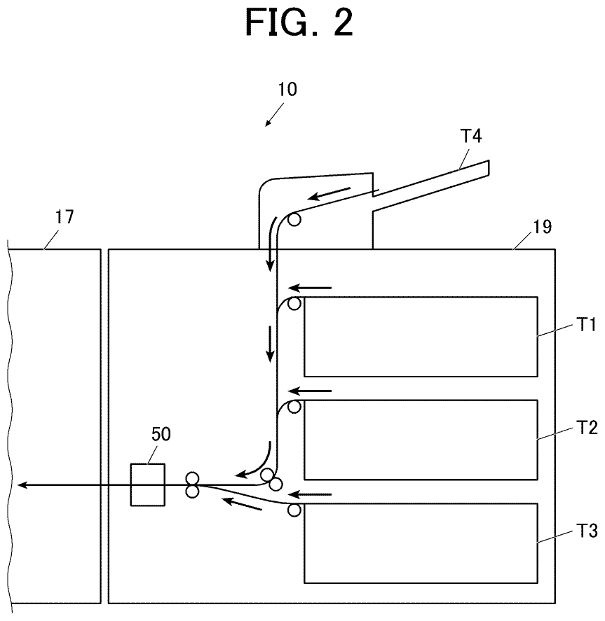

FIG. 2 shows an example of the configuration of the sheet feed section 19 of the image forming apparatus 10. The sheet feed section 19 includes a plurality of sheet feed trays T1 to T4, and supplies sheets stored in the sheet feed trays T1 to T4 to the image forming section 17. In the sheet feeding trays T1 to T4, sheets of various types or sizes are accommodated for each sheet feeding tray. In FIG. 2, the sheet feed tray T1 is provided at the upper stack of the sheet feed section main body having a three tray structure. The sheet feed tray T2 is provided at the middle stack of the sheet feed section main body. The sheet feed tray T3 is provided at the lower stack of the sheet feed section main body. The sheet feed tray T4 is a manual sheet feed tray. The sheets stored in the sheet feeding trays T1, T2, and T4 are bent in the vertical direction immediately after the start of conveyance in the substantially horizontal direction, and then are bent in the horizontal direction again. On the other hand, the sheets stored in the sheet feed tray T3 are conveyed in a substantially horizontal direction, and therefore, are supplied to the image forming section 17 with hardly being bent.

Hereinafter, the “sheet feed tray” may be simply referred to as the “tray”.

The media sensor 50 (sensor section) reads an attribute of the sheet and outputs the obtained data on the attribute to the controller 11. For example, as shown in FIG. 2, the media sensor 50 is provided on a path along which the sheet is conveyed from the sheet feed section 19 to the image forming section 17. The media sensor 50 includes various sensors such as a paper thickness sensor, a basis weight sensor, and a surface property sensor. The sheet thickness sensor measures the thickness of the sheet by detecting an axial position of a driven roller that is displaced according to the thickness of the sheet when the sheet is conveyed by a nip of a conveyance roller pair. The basis weight sensor is a transmission-type optical sensor, and measures the basis weight of the sheet by detecting an attenuation amount (transmittance) of light transmitted through the sheet. The surface property sensor is a reflection-type optical sensor and measures the surface property of the sheet by detecting specular reflection light and diffuse reflection light from the surface of the sheet. The media sensor 50 may also include a color sensor for detecting the color of the sheet, an optical sensor for detecting the size of the sheet, and the like.

The controller 11 associates the sheet profile with identification information (tray identification information) for identifying a tray that accommodates sheets, and stores the sheet profile and the identification information in the RAM 12 (association storage section).

In the RAM 12, a plurality of pairs of the associated sheet profiles and the tray identification information pieces may be stored.

The sheet profile includes a profile in which a sheet is associated with an attribute of the sheet read by the media sensor 50.

The sheet profile includes items such as sheet ID, sheet name, sheet type, sheet size, basis weight, paper color, punch hole, front/back adjustment, and printing conditions.

The “sheet ID” is the identification information for identifying the sheet.

The “sheet name” is the name of the sheet.

The “sheet type” is set from plain paper, high-quality paper, color paper, coated paper, and the like.

The “sheet size” is set from A3, A4, A5, B4, B5, irregular size (any size input by the user), and the like.

The “basis weight” is set from 62-74 g/m², 75-80 g/m², 81-91 g/m², 92-105 g/m², or the like.

The “paper color” is the information indicating the color of the sheet. The “paper color” is set from white, blue, green, red, yellow, gray, and the like.

Whether or not the sheet has punch holes is set under “punch hole(s)”.

In the “front/back adjustment”, adjustment values of the magnification, the shift, the skew, and the like for each of the front surface and the back surface of the sheet in double-sided printing are set.

In the “printing conditions”, adjustment values for sheet feed, density, transfer, fixing, and the like are set.

The controller 11 (acceptance unit) accepts selection of at least one of the sheet profile and the tray identifying information stored in the RAM 12. That is, when the controller 11 accepts selection of a sheet profile, the controller accepts selection of tray identification information or accepts selection of a sheet profile and tray identification information.

The controller 11 (registration unit) registers at least one of the sheet profile and the tray identification information, the selection of which has been accepted, in association with the tray.

In the RAM 12, the sheet profile and the tray identification information are stored in association with each other. Therefore, when the user selects the sheet profile, the controller 11 can also acquire the tray identification information from the correspondence stored in the RAM 12. Conversely, when the user selects the tray identification information, the controller 11 can also acquire the sheet profile from the correspondence relationship stored in the RAM 12.

Based on the association between the sheet profile and the tray identification information stored in the RAM 12, the controller 11 registers the sheet profile and the tray corresponding to the tray identification information in association with each other.

Based on at least one of the sheet profile and the tray identification information, the selection of which has been accepted, the controller 11 identifies the tray corresponding to the tray identification information. The controller 11 sets at least one of the sheet profile and the tray identification information, the selection of which has been accepted, to the specified tray. To be specific, when a sheet profile is selected, the controller 11 refers to the correspondence between the sheet profiles and the tray identification information stored in the RAM 12, acquires the tray identification information associated with the sheet profile, and identifies the tray corresponding to the tray identification information. When the tray identification information is selected, the controller 11 identifies the tray corresponding to the tray identification information.

After completion of a job executed in a state where the sheet profile and the tray identification information are stored in the RAM 12 in association with each other, the controller 11 registers at least one of the sheet profile and the tray identification information, the selection of which has been accepted, in association with the tray.

The controller 11 (loading unit) loads at least one of the sheet profile and the tray identification information to the tray by accepting at least one of the sheet profile and the tray identification information registered in association with the tray.

The controller 11 causes the RAM 12 (association storage section) to store first information in which the sheet profile is associated with the identification information (tray identifying information) for identifying the tray to accommodate sheets.

A plurality of pieces of first information may be stored in the RAM 12.

The controller 11 (reception unit) receives selection of the first information stored in the RAM 12.

The controller 11 (registration unit) registers the selected first information in association with the sheet profile included in the first information to the tray corresponding to the tray identification information included in the first information.

### (Configuration of Controller Apparatus)

As shown in FIG. 1, the controller apparatus 20 includes a controller 21, a RAM 22, a storage 23, a communicator 24, an operation part 25, and a display part 26.

The controller 21 includes a CPU and the like. The controller 21 reads various programs stored in the storage 23, develops the programs in the RAM 22, and performs various kinds of processing in cooperation with the programs.

The RAM 22 temporarily stores various programs, various kinds of date, parameters, and the like read from the storage 23 in various kinds of processing executed by the controller 21.

The storage 23 is a storage device including a hard disk, a nonvolatile semiconductor memory, or the like. For example, various programs and parameters and data necessary for executing the various programs are stored in the storage 23.

The communicator 24 transmits and receives data to and from an external device connected via the communication network N or the dedicated line L.

The operation part 25 receives an operation command from a user. The operation part 25 includes a keyboard, a mouse, and the like. The keyboard includes cursor keys, character input keys, various function keys, and the like. The operation part 25 outputs an operation signal corresponding to a key operation on the keyboard to the controller 21. The operation part 25 outputs an operation signal corresponding to a mouse operation to the controller 21.

The display part 26 includes a monitor such as an LCD. The display part 26 displays various screens according to a command of a display signal from the controller 21.

As the operation part 25 and the display part 26 of the controller apparatus 20, an operation part and a display part of the PC 40 may be used. Further, the operation part 15 and the display part 16 of the image forming apparatus 10 may be used as the operation part 25 and the display part 26 of the controller apparatus 20.

### (Operation of Image Forming System)

Next, an operation of the image forming system 100 will be described.

### <Profile Registration Processing>

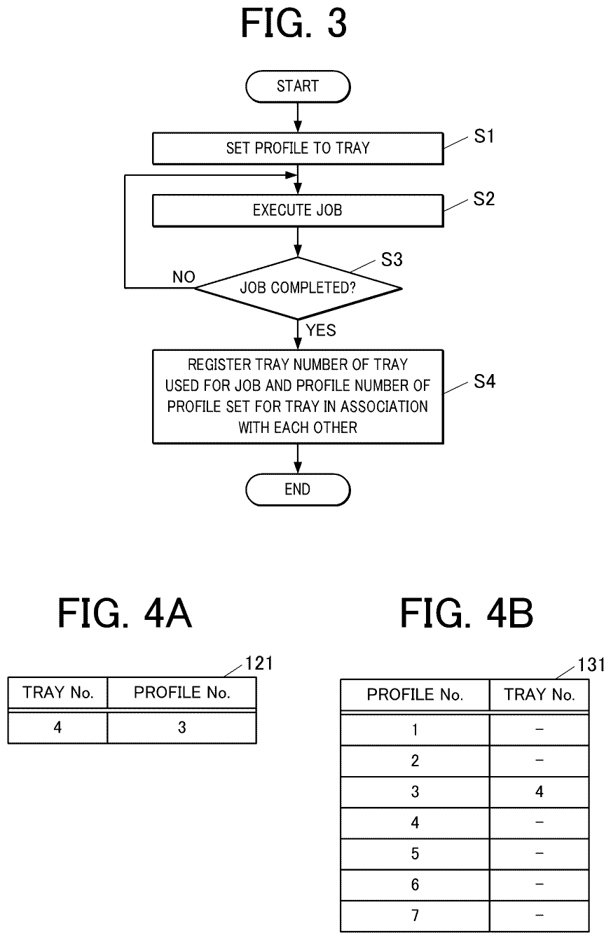

FIG. 3 is a flowchart showing profile registration processing executed in the image forming apparatus 10. The profile registration processing is for registering, in the storage 13, the correspondence between a sheet feed tray and a sheet profile temporarily stored in the RAM 12.

The user selects each item of the sheet profile for a specific sheet feed tray of the sheet feed section 19 by an operation from the operation part 15. Hereinafter, the “sheet profile” may be simply referred to as a “profile”.

The controller 11 sets the profile in which each item is selected by the user for the tray selected by the user (Step S1). To be specific, the controller 11 causes the RAM 12 to store the set profile. Here, data obtained by reading a sheet with the media sensor 50 in advance may be used for the attributes of the sheet in the profile. Furthermore, the controller 11 stores, in the RAM 12, identification information (tray number) of the tray for which a profile is set and identification information (profile number) of the profile in association with each other. Here, the RAM 12 stores the profile and the tray identification information in association with each other.

FIG. 4A is an example of a tray setting status table 121 stored in the RAM 12. In FIG. 4A, the profile of Profile No. 3 is associated with the tray of Tray No. 4 in the tray setting status table 121. The information stored in the tray setting status table 121 in which the profile and the tray identification information are associated with each other is “first information”.

Next, the user commands execution of the job from the operation part 15. In response to the execution command, the controller 11 causes the image forming section 17 to execute the job on the basis of the set profile (printing conditions and the like) using the sheets accommodated in the tray selected by the user (Step S2).

The controller 11 determines whether the job has been completed (Step S3).

If the job has not been completed (Step S3; NO), the processing returns to Step S2. The controller 11 continues the job.

When the job has been completed in Step S3 (Step S3; YES), the controller 11 proceeds to Step S4. In Step S4, the controller 11 registers the tray number of the tray used in the job and the profile number of the profile set for the tray in association with each other (Step S4). That is, the controller 11 registers, in the storage 13, the correspondence relationship stored in the RAM 12 in Step S1. Furthermore, the controller 11 also causes the storage 13 to store profile data including the setting content of the profile.

FIG. 4B is an example of a profile registration table 131 stored in the storage 13. In FIG. 4B, the profile of Profile No. 3 and the tray of Tray No. 4 are associated with each other in the profile registration table 131. No tray is associated with any profile having a profile number other than Profile No. 3.

Thus, the profile registration processing is completed.

The data of the tray setting status table 121 and the profile data temporarily stored in the RAM 12 are deleted when the power of the image forming apparatus 10 is turned off, when the sheet setting for the tray is changed, or the like.

On the other hand, the data of the profile registration table 131 and the profile data stored in the storage 13 are retained in a nonvolatile manner even when the image forming apparatus 10 is turned off.

Further, in the profile registration processing (see FIG. 3), since the tray setting used in the job is set as the registration target, the step of selecting “at least one of the sheet profile and the tray identification information” as the registration target is omitted. That is, the pair of the profile and the tray set in Step S1 is handled as being automatically selected. In a case where a plurality of correspondence relationships are set in Step S1, the controller 11 may determine the registration target in Step S4 by the user selecting one or more correspondence relationships from among the plurality of set correspondence relationships.

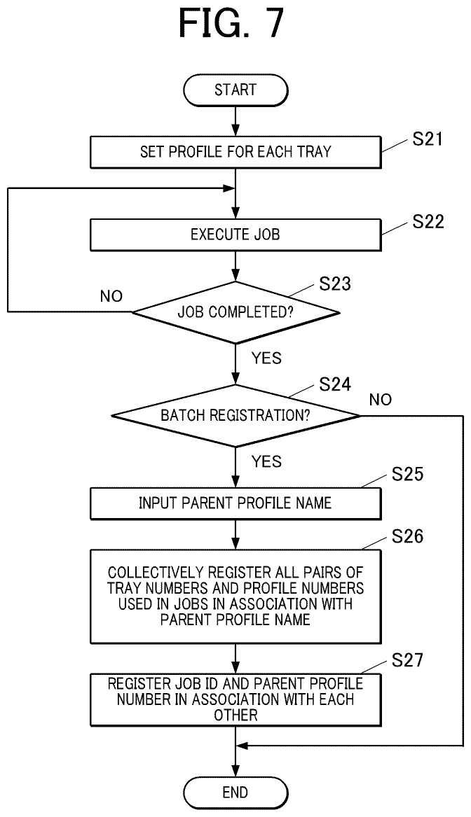

In the profile registration processing, the case where after a job is completed, the controller 11 registers the tray number of the tray used in the job and the profile number of the profile set for the tray in association with each other has been described. Alternatively, when the sheet setting or the like for the tray is not changed during execution of a job, the controller 11 may associate and register, before or during execution of the job, the profile and the tray identification information stored in association with each other in the RAM 12. Further, even when the sheet setting or the like for the tray is changed during execution of the job, the controller 11 may associate and register the profile and the tray identification information stored in association in the RAM 12 before or during execution of the job, and may associate and register the tray number of the tray used in the job and the profile number of the profile set for the tray again after execution of the job. This makes it possible to obtain the same effect as the profile registration processing eventually. The same can be said about batch registration processing upon job completion described later (see FIG. 7).

### <Profile Loading Processing>

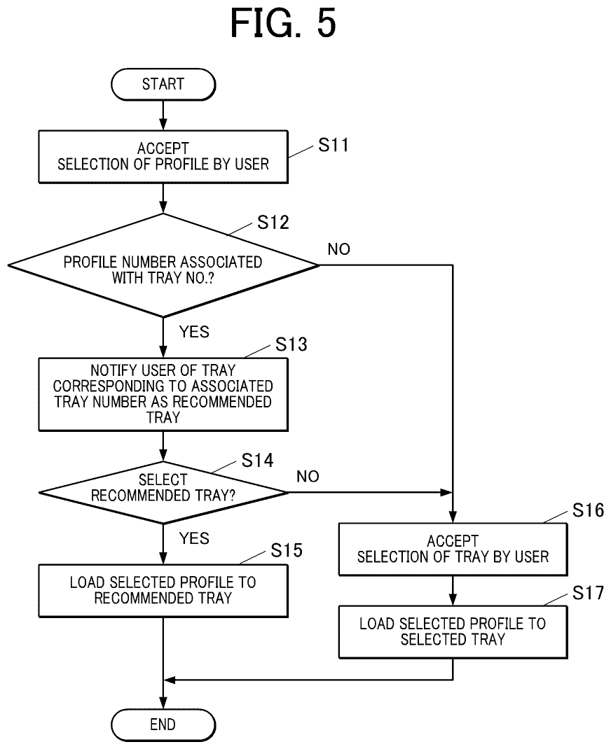

FIG. 5 is a flowchart showing profile loading processing executed in the image forming apparatus 10. The profile loading processing is for loading data that is registered in the storage 13 and in which a sheet feed tray and a sheet profile are associated with each other.

The user selects one of the profiles registered in the storage 13 by an operation on the operation part 15.

Specifically, the controller 11 allows the display part 16 to display the profile registered in the storage 13. The controller 11 receives a user's selection of a profile (Step S11).

Next, the controller 11 determines whether the tray number is associated with the profile number of the selected profile in the profile registration table 131 (see FIG. 4B) of the storage 13 (Step S12). For example, in a case where the profile number of the selected profile is “3”, the tray No. 4 is associated.

In a case where a tray number is associated with the profile number of the selected profile (Step S12; YES), the process proceeds to Step S13. In Step S13, the controller 11 notifies the user of a tray corresponding to the tray number linked to the profile number of the selected profile as a recommended tray. For example, the controller 11 allows the display part 16 to display a message informing the recommended tray.

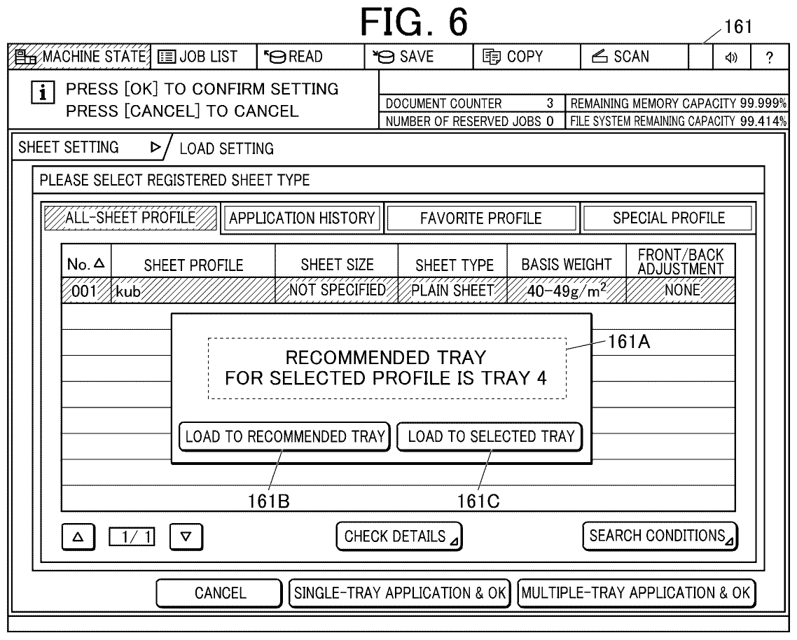

FIG. 6 shows an example of a recommended tray notification screen 161 to be displayed on the display part 16. The recommended tray notification screen 161 includes a message area 161A, a “load to recommended tray” button 161B, and a “load to selected tray” button 161C.

The information of “Recommended tray is Tray 4 (tray of No. 4)” is displayed in the message area 161A.

The “load to recommended tray” button 161B is a button for giving a command of loading the selected profile to the recommended tray.

The “load to selected tray” button 161C is a button for giving a command of loading the selected profile to a tray other than the recommended tray.

After Step S13, the controller 11 determines whether to select a recommended tray as a setting destination of the selected profile (Step S14).

In a case of selecting a recommended tray as a setting destination of the selected profile (Step S14; YES), that is, in a case where the “load to recommended tray” button 161B on the recommended tray notification screen 161 is pressed, the process transitions to Step S15. In Step S15, the controller 11 loads the selected profile to the recommended tray. The controller 11 acquires data of the selected profile from the storage 13 and sets the data to the recommended tray.

In Step S12, if the tray number is not associated to the profile number of the selected profile (Step S12; NO), the process proceeds to Step S16.

In addition, in Step S14, when the recommended tray is not selected as the setting destination of the selected profile (Step S14; NO), the process proceeds to Step S16. “NO” in Step S14 corresponds to a case where the “loads to selected tray” button 161C of the recommended tray notification screen 161 has been pressed.

In Step S16, the controller 11 displays a list of trays (if “NO” in Step S14, a list of trays other than the recommended tray) on the display part 16, and accepts selection of a tray by the user.

Next, the controller 11 loads the selected profile for the selected tray (Step S17). The controller 11 acquires data of the selected profile from the storage 13 and sets the data to the selected tray.

After Step S15 or S17, the profile loading processing ends.

As described above, according to the first embodiment, the controller 11 of the image forming apparatus 10 registers a sheet profile in association with a tray. Thus, the user does not need to select a tray every time for the sheet profile to be used, which reduces time and effort for tray setting. Therefore, the controller 11 can reuse the sheet profile set for the tray.

Further, the controller 11 receives a sheet profile registered in association with the tray. Then, the controller 11 loads the sheet profile for the tray. The user does not need to consider the type of sheet, printing conditions, and the like for the tray every time. That is, the user can execute the job without associating the tray with the sheet profile. In other words, it is possible to reproduce which sheet profile has been used for which tray by a user in the past. Furthermore, a sheet profile adjusted for a specific tray is not erroneously loaded for another tray, and print quality is improved. The controller 11 can load a past tray setting state, and can reproduce a state where quality is guaranteed.

Furthermore, after completion of the job, the controller 11 registers at least one of the sheet profile and the tray identification information in association with the tray. Thus, the controller 11 can register the correspondence relation between the sheet profile and the tray set in the job.

### Second Embodiment

Next, a second embodiment to which the present invention is applied will be described.

In the second embodiment, a case will be described in which sheet profiles are respectively set for trays and collectively registered and the registered data is used later.

Since the image forming system according to the second embodiment has the same configuration as the image forming system 100 according to the first embodiment, FIG. 1 is used, and a detailed description thereof will be omitted. Hereinafter, configurations and processes characteristic of the second embodiment will be described.

### (Configuration of Image Forming Apparatus)

The controller 11 (registration unit) of the image forming apparatus 10 registers, in the storage 13, at least one of the sheet profiles and the tray identification information pieces the selection of which has been accepted in association with each tray from among a plurality of pairs of the sheet profiles and the tray identification information pieces stored in the RAM 12.

The controller 11 (registration unit) registers, as the second information, at least two or more pieces of the first information, the selection of which has been received, from among a plurality of pieces of the first information (sets of sheet profiles and tray identification information pieces) stored in the RAM 12.

Upon accepting the first information registered in the storage 13, the controller 11 (loading unit) loads, for the accepted first information, the sheet profile included in the first information to the tray corresponding to the tray identification information included in the first information.

Upon accepting the second information registered in the storage 13, the controller 11 (loading unit) loads, for each piece of the first information included in the accepted second information, the sheet profile included in the first information to the tray corresponding to the tray identification information included in the first information.

The controller 11 (registration unit) registers at least one of the sheet profile and the tray identifying information in association with the information on the job when the sheet profile and the tray identifying information are stored in the RAM 12 in association with each other.

Alternatively, the controller 11 may register at least one of the sheet profile and the tray identification information in association with the information on the job when registering at least one of the sheet profile and the tray identification information in association with the tray.

The controller 11 (loading unit) loads at least one of the sheet profile and the tray identification information for the tray by accepting the information relating to the job registered in the storage 13.

The controller 11 (registration unit) registers the tray and the sheet profile corresponding to the tray identification information in association with the information on the job when the first information is stored in the RAM 12.

Alternatively, the controller 11 may register the tray and the sheet profile corresponding to the tray identification information in association with the information on the job when the sheet profile is registered in association with the tray corresponding to the tray identification information.

Upon accepting the information on the job registered in the storage 13, the controller 11 (loading unit) loads the sheet profile for the tray corresponding to the tray identification information registered in association with the accepted information on the job.

Based on the loading of the data registered in the storage 13, the controller 11 (notification unit) provides notification to place, in the tray, the sheets related to the loaded sheet profile or the sheets related to the sheet profile corresponding to the loaded tray identification information.

### (Operation of Image Forming System)

Next, an operation of the image forming system according to the second embodiment will be described.

### <Batch Registration Processing Upon Job Completion>

FIG. 7 is a flowchart showing batch registration processing upon job completion to be executed in the image forming apparatus 10. The batch registration processing upon job completion is processing in which, with the completion of a job as a trigger, a plurality of correspondences between sheet feed trays and sheet profiles temporarily stored in the RAM 12 can be collectively registered in the storage 13.

The user selects, by an operation from the operation part 15, each item of the profile for each of the trays to be the setting targets among the plurality of trays of the sheet feed section 19.

The controller 11 sets a profile in which each item is selected by the user for each tray selected by the user (Step S21). To be specific, the controller 11 causes the RAM 12 to store each of the set profiles. Here, data obtained by reading a sheet with the media sensor 50 in advance may be used for the attributes of the sheet in the profile. Furthermore, the controller 11 associates identification information (tray number) of the trays for which profiles have been set with identification information (profile number) of the profiles, and stores each pair in the RAM 12.

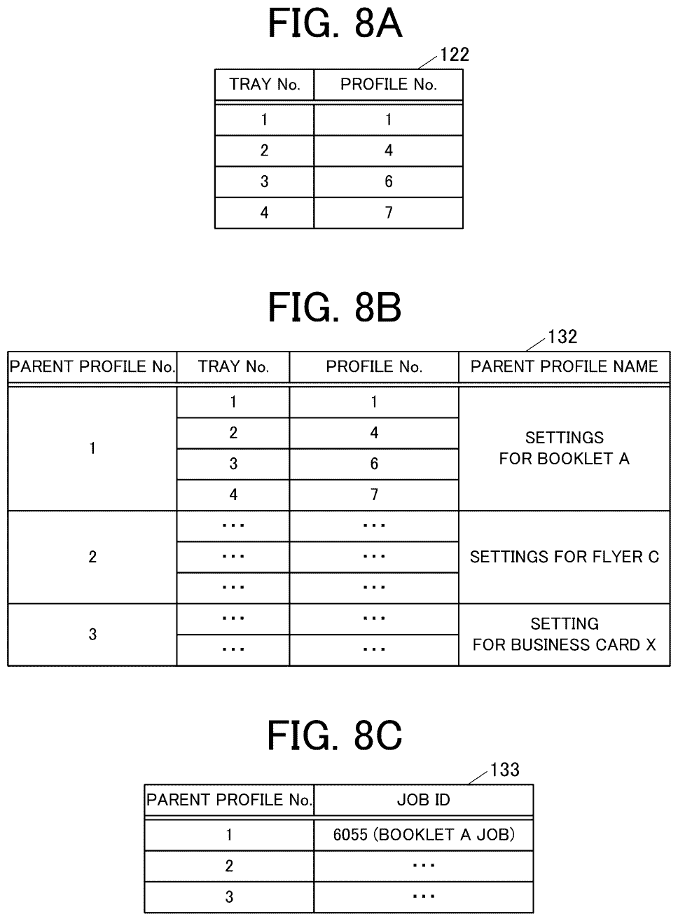

FIG. 8A shows an example of the tray setting status table 122 stored in the RAM 12. In FIG. 8A, the tray of Tray No. 1 and the profile of Profile No. 1 are associated with each other in the tray setting status table 122. The tray of Tray No. 2 and the profile of Profile No. 4 is associated with each other.

The tray of Tray No. 3 and the profile of Profile No. 6 are associated with each other. The tray of Tray No. 4 and the profile of Profile No. 7 are associated with each other. Information of one line stored in the tray setting status table 122, that is, information in which the profile and the tray identification information are associated with each other is the “first information”.

For example, in a job of creating a booklet, a cover sheet profile, a main body profile, a back cover sheet profile, an insertion sheet profile, and the like are set for each tray.

A user provides a command to execute the job from the operation part 15. In response to the execution command, the controller 11 causes the image forming section 17 to execute the job based on the profile (printing conditions and the like) set for each tray by using the sheets accommodated in each tray selected by the user (Step S22).

The controller 11 determines whether the job has been completed (Step S23).

If the job has not been completed (Step S23; NO), the process returns to Step S22. The controller 11 continues the job.

In Step S23, when the job is completed (Step S23; YES), the controller 11 determines whether or not to collectively register the correspondence relationships between the trays and the profiles used in the job (Step S24). For example, the controller 11 causes the display part 16 to display a message asking whether to collectively register the setting status of the profiles for the respective trays at the time of job execution. As described above, the controller 11 may collectively register the setting status of the profile for each tray before or during execution of a job.

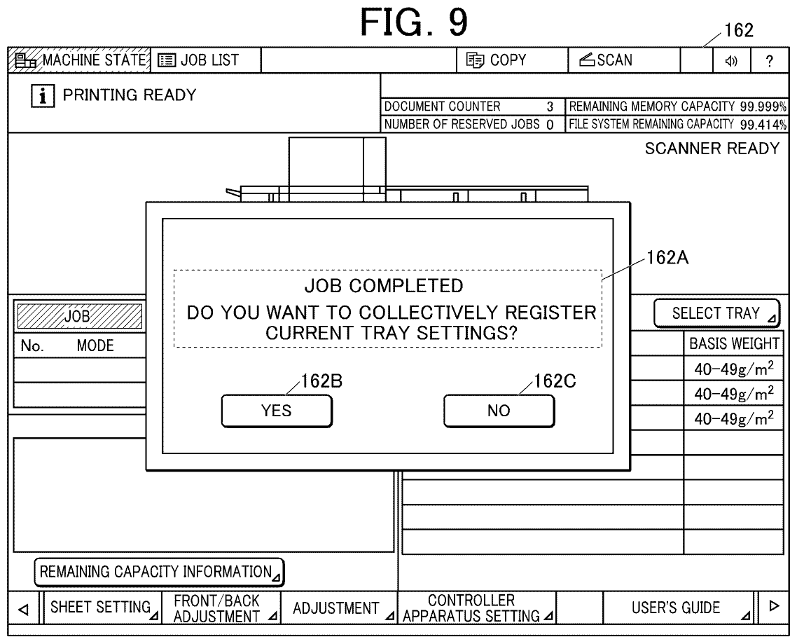

FIG. 9 shows an example of a batch registration confirmation screen 162 displayed on the display part 16. The batch registration confirmation screen 162 includes a message area 162A, a YES button 162B, and a NO button 162C.

In the message area 162A, a message for confirming whether to collectively register the setting contents of each tray is displayed.

The YES button 162B is a button for giving a command of batch registration of the setting contents of each tray. That is, pressing the YES button 162B corresponds to selecting all of the correspondences between tray numbers and profile numbers included in the tray setting status table 122 stored in the RAM 12.

The NO button 162C is a button for giving a command of no batch registration of the setting contents of each tray.

In Step S24, if the batch registration is to be performed (Step S24; YES), that is, the YES button 162B on the batch registration confirmation screen 162 is pressed, the controller 11 causes the display part 16 to display a parent profile name input screen. Here, the “parent profile” is data in which the setting states of the profiles for the respective trays are collectively registered. The controller 11 accepts an input of a parent profile name (Step S25).

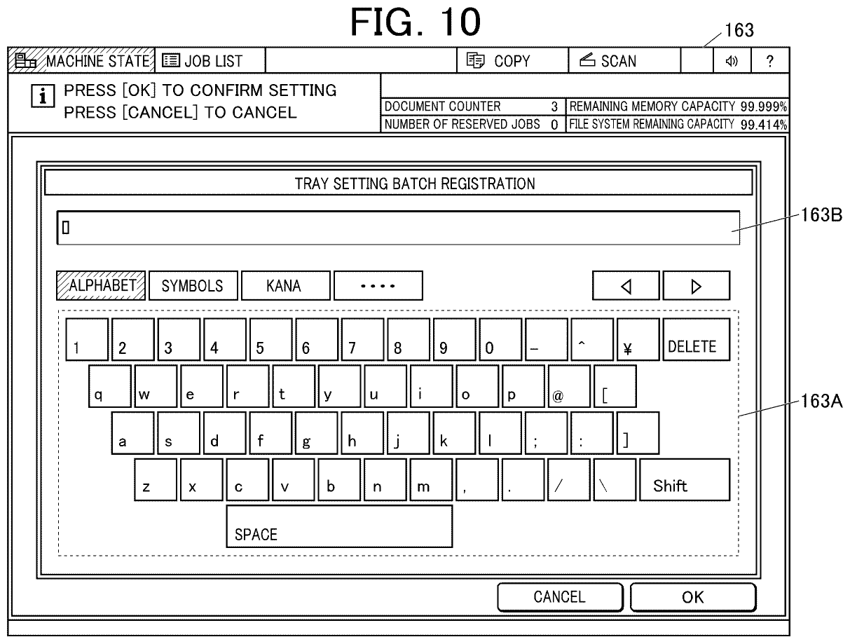

FIG. 10 shows an example of a parent profile name input screen 163 to be displayed on the display part 16. The parent profile name input screen 163 includes a software keyboard area 163A and a parent profile name display area 163B.

In the software keyboard area 163A, a keyboard for inputting numbers and letters is displayed. The user performs a touch operation on the software keyboard area 163A via the operation part 15 (touch screen) to input the parent profile name.

The parent profile name input via the software keyboard area 163A is displayed in the parent profile name display area 163B.

Next, the controller 11 collectively registers pairs of the tray numbers of all the trays used in the job and the profile numbers of the profiles set for the trays in association with the parent profile name (Step S26). That is, the controller 11 associates the plurality of correspondences stored in the RAM 12 in Step S21 with the parent profile name and registers them in the storage 13. The controller 11 also causes the storage 13 to store profile data including the setting contents of each profile (profile specified by the profile number).

FIG. 8B shows an example of a parent profile registration table 132 stored in the storage 13. In the parent profile registration table 132, a parent profile including a plurality of sets of tray numbers and profile numbers, parent profile names, and parent profile numbers are associated with each other. In the parent profile registration table 132, each pair of a tray number and a profile number set in a certain parent profile is the “first information”. A plurality of pieces of the “first information” included in a certain parent profile is the “second information”.

Next, the controller 11 associates the job ID corresponding to the job executed in Step S22 with the parent profile number and registers them in the storage 13 (Step S27).

FIG. 8C shows an example of a job history table 133 stored in the storage 13. In the job history table 133, a parent profile number and a job ID are associated with each other. For example, in FIG. 8C, the parent profile No. “1” and the job ID “6055” are associated with each other.

After Step S27 or when the batch registration is not performed in Step S24 (Step S24; NO), that is, when the NO button 162C of the collective registration confirmation screen 162 is pressed, the batch registration process upon job completion is completed.

The case where the controller 11 registers the parent profile after the job is completed in the batch registration processing upon job completion (see FIG. 7) has been described. Alternatively, the controller 11 may collectively register the contents set in Step S1 as a parent profile, and then execute a job in accordance with the settings of the parent profile. That is, the controller 11 may collectively register a plurality of pairs of profiles and tray identification information pieces stored in association with each other in the RAM 12 before execution of a job. Furthermore, the controller 11 may register information on a job executed after registration of the parent profile, in association with the parent profile. Further, the controller 11 may collectively register a plurality of pairs of the profiles and the tray identification information pieces stored in association with each other in the RAM 12 during execution of the job.

### <Manual Batch Registration Processing>

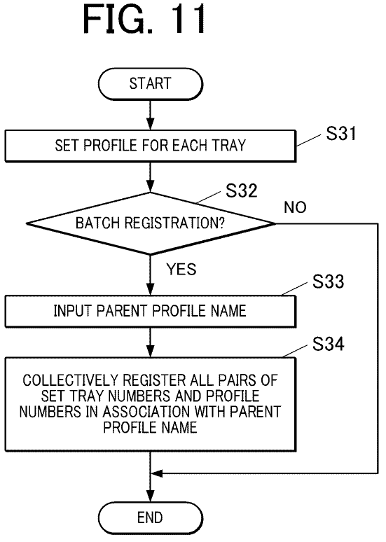

FIG. 11 is a flowchart showing manual batch registration processing executed in the image forming apparatus 10. The manual batch registration processing is processing in which a plurality of correspondences between sheet feed trays and sheet profiles temporarily stored in the RAM 12 can be collectively registered in the storage 13 in response to a user's operation.

The processing of Step S31 is the same as the processing of Step S21 of the batch registration processing upon job completion (see FIG. 7), and thus the description thereof will be omitted.

In Step S31, for example, as in the tray setting status table 122 shown in FIG. 8A, a plurality of correspondence relationships between tray numbers and profile numbers are stored in the RAM 12.

Next, the controller 11 determines whether to collectively register the set correspondences between trays and profiles (Step S32). For example, the controller 11 causes a batch registration button to be displayed on the sheet setting screen displayed on the display part 16.

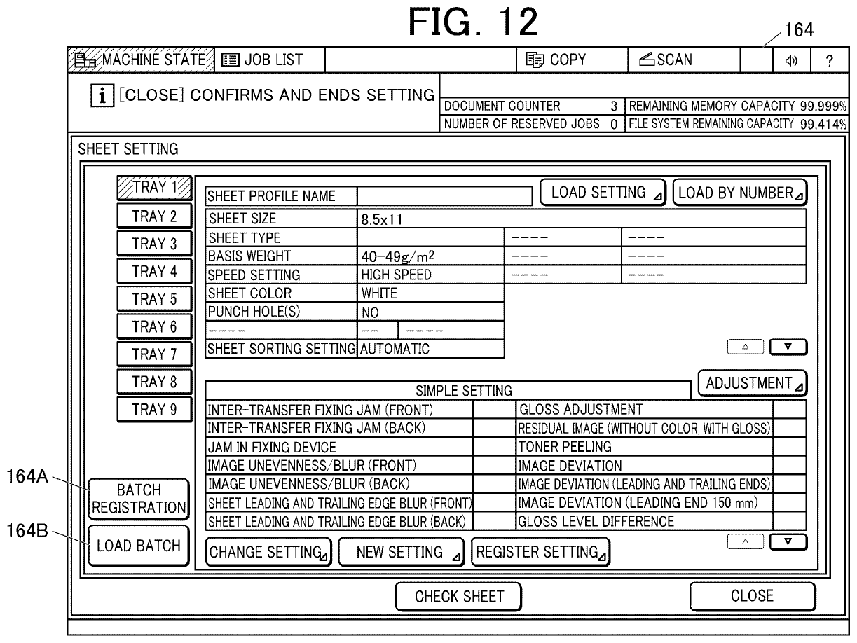

FIG. 12 shows an example of a sheet setting screen 164 to be displayed on the display part 16. The sheet setting screen 164 includes a batch registration button 164A. The batch registration button 164A is a button for giving a command of collectively registering the setting content of each tray. Pressing the batch registration button 164A of the user corresponds to selecting all of the plurality of correspondences included in the tray setting status table 122 stored in the RAM 12.

If batch registration is to be executed in Step S32 (Step S32; YES), that is, if the batch registration button 164A on the sheet setting screen 164 has been pressed, the controller 11 causes the display part 16 to display a parent profile name input screen. The parent profile name input screen is the same as the parent profile name input screen 163 shown in FIG. 10. The controller 11 accepts an input of a parent profile name (Step S33).

Next, the controller 11 collectively registers the pairs of the tray numbers of all the set trays and the profile numbers of the profiles set in the trays in association with the parent profile name (Step S34). That is, the controller 11 associates the plurality of correspondences stored in the RAM 12 in Step S31 with the parent profile name and registers them in the storage 13. Furthermore, the controller 11 also causes the storage 13 to store profile data including setting content of each profile.

The parent profile registration table in which the date is registered in Step S34 is the same as the parent profile registration table 132 shown in FIG. 8B.

After Step S34 or in Step S32, when the batch registration is not executed (Step S32; NO), the manual batch registration processing ends.

### <Automatic Loading Processing>

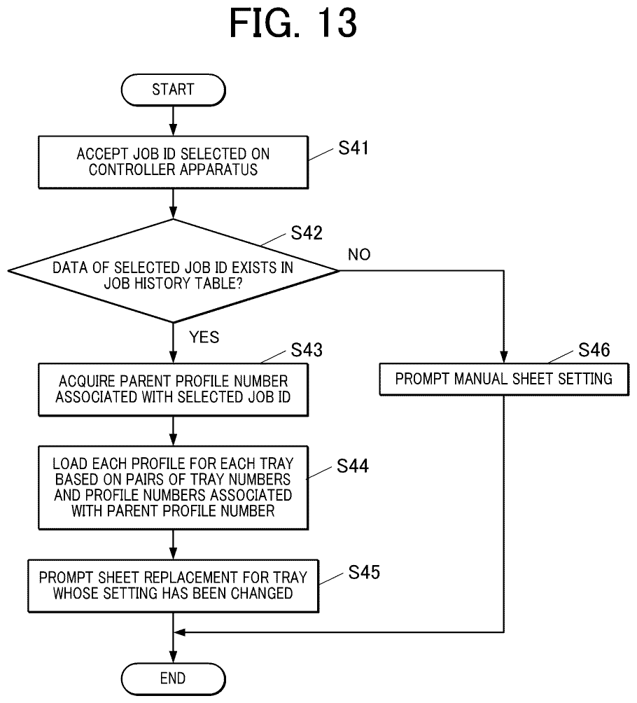

FIG. 13 is a flowchart showing automatic loading processing executed in the image forming apparatus 10. The automatic loading process is for collectively reproducing the same tray setting as that of the job selected by the user from the jobs registered in the past.

At the time of job execution, the user selects a job ID by an operation on the operation part 25 of the controller apparatus 20. The controller 21 of the controller apparatus 20 notifies the image forming apparatus 10 of the selected job ID via the communicator 24.

In the image forming apparatus 10, the controller 11 accepts the job IDs selected by the controller apparatus 20 via the communicator 14 (Step S41). The “acceptance of a job ID” in Step S41 corresponds to the “acceptance of information on a job”, the “acceptance of a parent profile (second information) associated with the job ID”, and the “acceptance of a sheet profile and tray identification information (first information)”.

Next, the controller 11 determines whether data on the selected job ID exists in the job history table 133 (see FIG. 8C) stored in the storage 13 (Step S42).

If any data on the selected job ID is present in the job history table 133 (Step S42; YES), the processing proceeds to Step S43. In Step S43, the controller 11 acquires, from the job history table 133 stored in the storage 13, the parent profile number associated with the selected job ID.

For example, when the user selects the job ID “6055”, the controller 11 acquires, from the job history table 133, the parent profile No. “1” associated with the selected job ID “6055”.

Next, the controller 11 loads each profile for each tray based on the set of the tray numbers and the profile numbers associated with the parent profile number (Step S44). For example, the controller 11 refers to the parent profile registration table 132 (see FIG. 8B) stored in the storage 13, and acquires all the pairs of tray numbers and profile numbers associated with the parent profile No. “1”. The controller 11 collectively sets the profiles corresponding to the profile numbers in the trays corresponding to the tray numbers for each of the acquired pairs.

Here, the controller 11 causes the display part 16 to display a message prompting sheet replacement for the tray whose setting has been changed during the batch setting (Step S45).

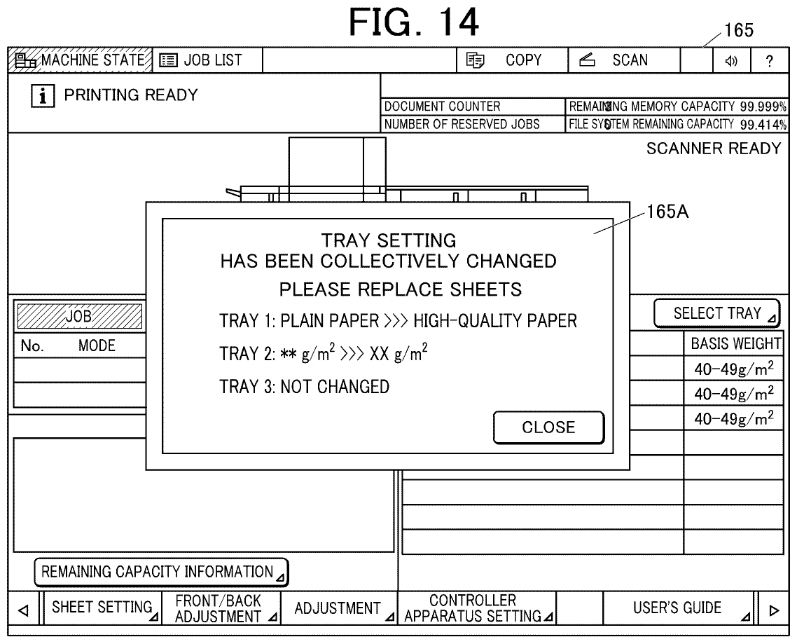

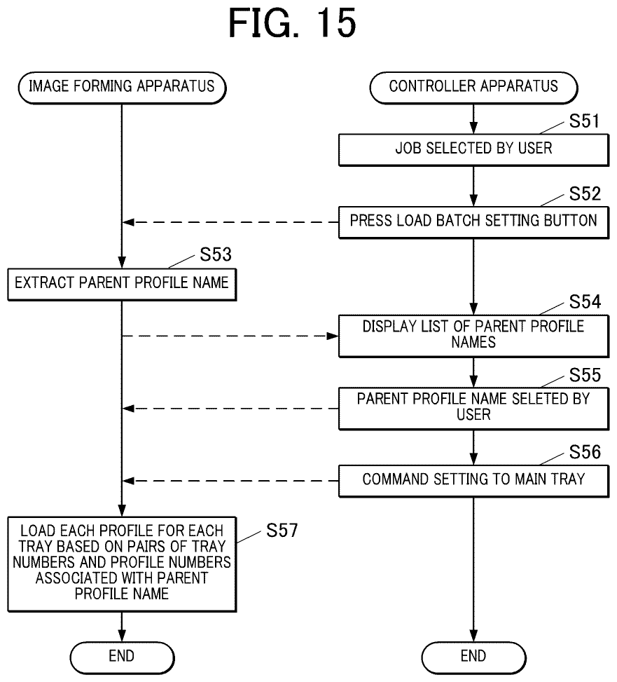

FIG. 14 shows an example of a sheet replacement instruction screen 165 to be displayed on the display part 16. The sheet replacement instruction screen 165 includes a message area 165A. In the message area 165A, information indicating that the tray settings have been collectively changed and the sheet attributes (type, size, basis weight, and the like) before and after the change for each tray are displayed.

If the selected job ID is not present in the job history table 133 in Step S42 (Step S42; NO), the controller 11 prompts the user to perform manual sheet setting (Step S46). For example, the controller 11 causes the display part 16 to display a screen for setting a tray and a profile, and receives an operation from the operation part 15.

After Step S45 or Step S46, the automatic loading processing ends.

In the PC 40 connected to the image forming apparatus 10 via the communication network N, a display indicating that the profiles have been collectively set for the respective trays or a display prompting sheet replacement may be provided.

<Manual Loading Processing from Controller Apparatus>

FIG. 15 is a ladder chart showing manual loading processing from the controller apparatus executed in the image forming apparatus 10 and the controller apparatus 20. This processing is for collectively reproducing the tray settings based on the parent profile registered in the past in accordance with the operation from the controller apparatus 20.

At the time of job execution, a user selects a job to be processed, by an operation from the operation part 25 in the controller apparatus 20. The job selected here is a job to be executed this time and is a job that the user wants to execute using the parent profile. The controller 21 of the controller apparatus 20 acquires information indicating the selected job (Step S51).

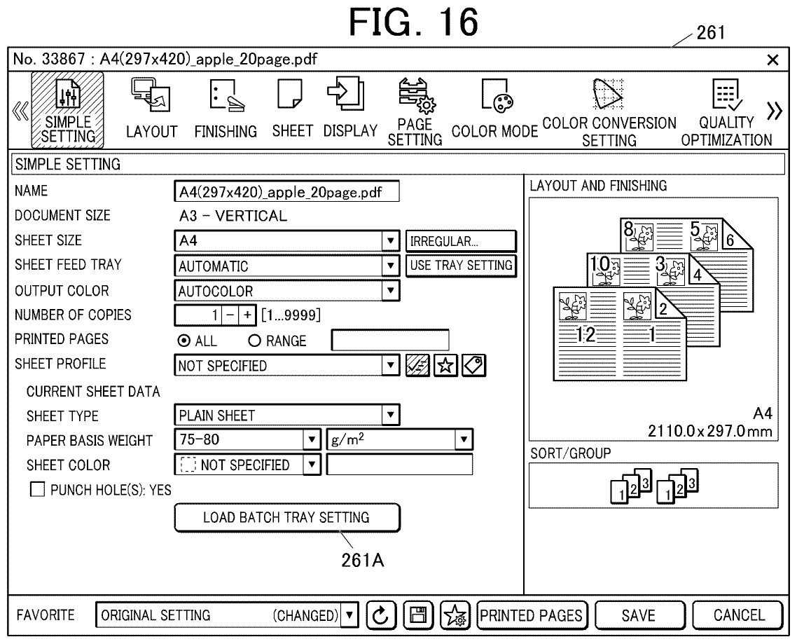

FIG. 16 shows an example of a tray setting screen 261 displayed on the display part 26 of the controller apparatus 20. The tray setting screen 261 includes a batch tray setting load button 261A in addition to setting areas of the respective items of the sheet profile for each tray.

In the controller apparatus 20, the user presses the collective tray setting load button 261A by an operation from the operation part 25. The controller 21 of the controller apparatus 20 transmits information indicating that the batch tray setting load button 261A has been pressed to the image forming apparatus 10 via the communicator 24 (Step S52).

In the image forming apparatus 10, the controller 11 extracts the registered parent profile name with reference to the parent profile registration table 132 (see FIG. 8B) stored in the storage 13 (Step S53). Then, the controller 11 transmits display data for displaying a list of parent profile names to the controller apparatus 20 via the communicator 14.

In the controller apparatus 20, the controller 21 causes the display part 26 to display a list of parent profile names (Step S54).

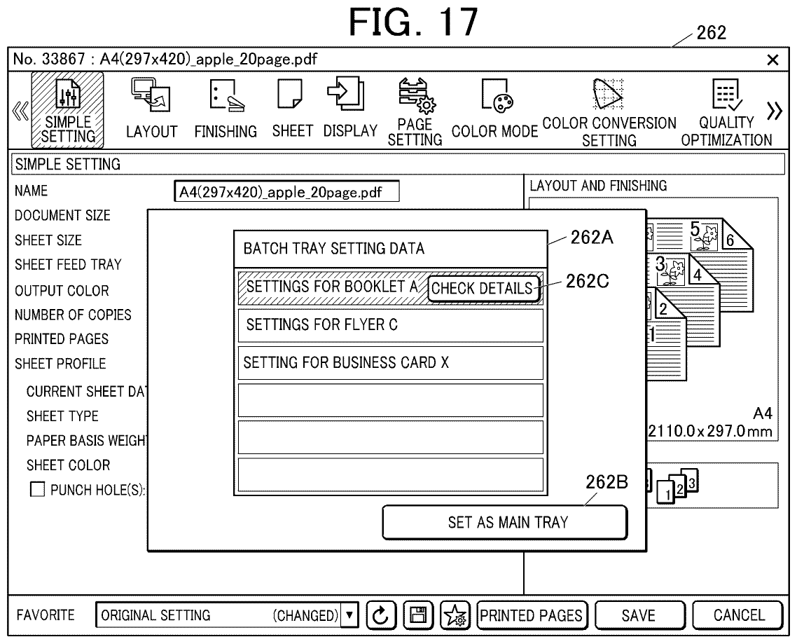

FIG. 17 shows an example of a parent profile list screen 262 to be displayed on the display part 26 of the controller apparatus 20. The parent profile list screen 262 includes a list area 262A, a “set to main tray” button 262B, and the like.

In the list area 262A, a list of parent profile names registered in the storage 13 is displayed. When one of the parent profile names is selected in the list area 262A, a detail check button 262C is displayed for the selected parent profile name. When the detail check button 262C is pressed, the details of the corresponding parent profile are acquired from the image forming apparatus 10 and displayed on the display part 26. The data of the parent profile includes a plurality of pairs of the associated tray numbers and profile numbers.

The “set to main tray” button 262B is a button for commanding of setting the parent profile related to the parent profile name selected in the list region 262A to the tray of the main body (the image forming apparatus 10).

The user selects one of the parent profile names from the list of parent profile names by an operation on the operation part 25 of the controller apparatus 20. To be more specific, the user selects any one parent profile name in the list area 262A of the parent profile list screen 262. The controller 21 of the controller apparatus 20 transmits the selected parent profile name to the image forming apparatus 10 via the communicator 24 (Step S55).

In response, the controller 11 of the image forming apparatus 10 “accepts the parent profile (second information)”.

Next, the user operates the operation part 25 of the controller apparatus 20 to give a command of setting the parent profile corresponding to the selected parent profile name in the main tray. To be specific, the user presses a “set to main tray” button 262B on the parent profile list screen 262. The controller 21 of the controller apparatus 20 transmits to the image forming apparatus 10 via the communicator 24 information indicating that the setting to the main tray has been commanded (Step S56).

In the image forming apparatus 10, the controller 11 loads each profile for each tray, based on the pairs of the tray numbers and the profile numbers associated with the selected parent profile name (Step S57). For example, the controller 11 acquires, from the parent profile registration table 132 (see FIG. 8B) stored in the storage 13, all of the pairs of tray numbers and profile numbers associated with the selected parent profile name. The controller 11 collectively sets the profiles corresponding to the profile numbers in the trays corresponding to the tray numbers for each of the acquired pairs.

Here, the manual loading processing from the controller apparatus ends.

Also in the manual loading processing from the controller apparatus, similarly to the automatic loading processing (see FIG. 13), the controller 11 may cause the display part 16 to display a message prompting sheet replacement for the tray whose setting has been changed.

<Manual Loading Processing from Main Body Screen>

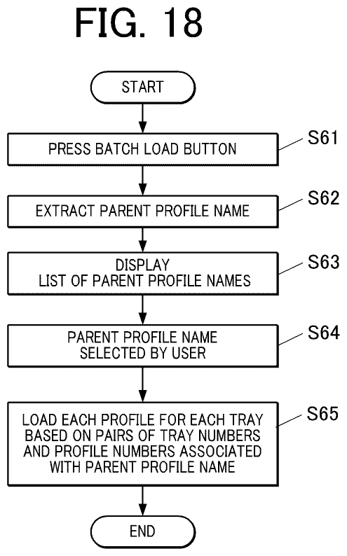

FIG. 18 is a flowchart showing manual loading processing executed in the image forming apparatus 10 from the main body screen. This processing is for collectively reproducing the tray setting based on the parent profile registered in the past in accordance with the operation from the main body screen (operation part 15) of the image forming apparatus 10.

The controller 11 causes the display part 16 to display a sheet setting screen. The sheet setting screen is the same as the sheet setting screen 164 shown in FIG. 12. The sheet setting screen 164 includes a batch loading button 164B. The batch loading button 164B is a button for giving a command of collectively loading the setting content of each tray.

The user presses the batch loading button 164B of the sheet setting screen 164 by an operation from the operation part 15. The controller 11 accepts that the batch loading button 164B has been pressed (Step S61).

The controller 11 refers to the parent profile registration table 132 (see FIG. 8B) stored in the storage 13, and extracts the registered parent profile name (Step S62). Then, the controller 11 causes the display part 16 to display the list of parent profile names (Step S63).

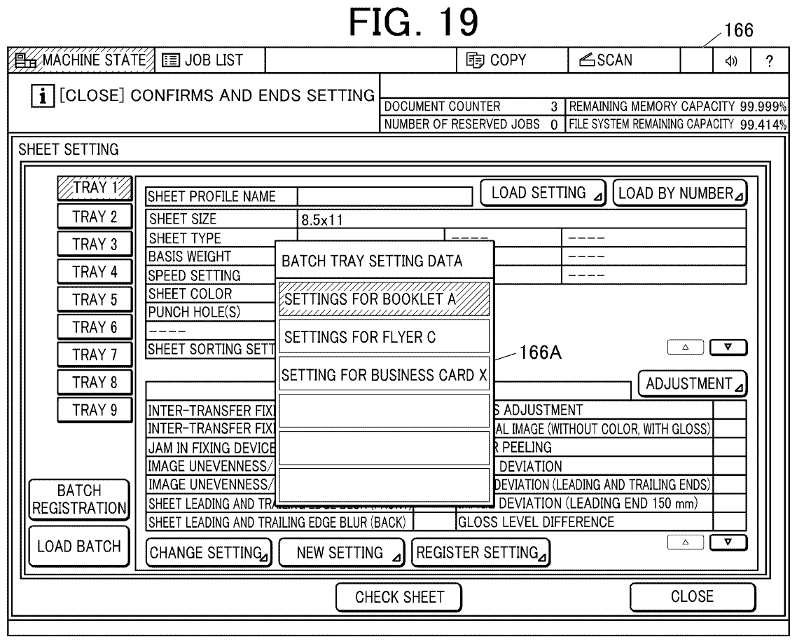

FIG. 19 shows an example of a parent profile list screen 166 to be displayed on the display part 16. The parent profile list screen 166 includes a list area 166A and the like.

In the list area 166A, the list of parent profile names registered in the storage 13 is displayed.

The user selects any one parent profile name from the list of parent profile names by an operation from the operation part 15. The controller 11 accepts a selection of the selected parent profile name (Step S64). That is, the controller 11 accepts the second information.

Next, the controller 11 loads each profile for each tray, based on the pairs of the tray numbers and the profile numbers associated with the selected parent profile name (Step S65). For example, the controller 11 acquires, from the parent profile registration table 132 (see FIG. 8B) stored in the storage 13, all of the pairs of tray numbers and profile numbers associated with the selected parent profile name. The controller 11 collectively sets the profiles corresponding to the profile numbers in the trays corresponding to the tray numbers for each of the acquired pairs.

Here, the manual loading processing from the main body screen is completed.

Also in the manual loading processing from the main body screen, similarly to the automatic loading processing (see FIG. 13), the controller 11 may cause the display part 16 to display a message prompting sheet replacement for the tray whose setting has been changed.

As described above, according to the second embodiment, the controller 11 of the image forming apparatus 10 collectively registers a plurality of pairs of the sheet profiles and the trays associated with each other. This makes it unnecessary for the user to select each tray for a plurality of sheet profiles. Therefore, the controller 11 can reuse the sheet profile set for each tray. In particular, in a case of a booklet type job in which a plurality of types of sheets is loaded in a plurality of trays to perform printing, it is highly effective to collectively register the trays and the sheet profiles in association with each other for a plurality of trays.

In addition, the controller 11 registers, as the second information, at least two or more pieces of the first information the selection of which has been accepted from among a plurality of pieces of the first information (pairs of sheet profiles and tray identification information) stored in the RAM 12. For example, the first information indicates the correspondence relationship of one line of the tray setting status table 122 shown in FIG. 8A. The second information indicates a plurality of correspondence relationships included in data related to one parent profile in the parent profile registration table 132 shown in FIG. 8B. Since the controller 11 collectively registers a plurality of pairs of sheet profiles and tray identifying information pieces, the sheet profiles and the tray identification information pieces can be used later in a unit (parent profile) registered.

The user may select a plurality of pieces of the first information (a part of the stored first information) from the plurality of pieces of the first information stored in the RAM 12, and the controller 11 may collectively register the selected plurality of pieces of the first information.

In addition, the controller 11 accepts a parent profile (second information) registered in the storage 13, and loads each sheet profile for each tray based on a correspondence relationship (a pair of a paper profile and tray identification information) included in the parent profile. This makes it unnecessary for the user to select each tray for a plurality of sheet profiles.

The controller 11 may allow the user to select a part of the correspondence relationships (the first information) included in the parent profile (the second information) registered in the storage 13 and partially use the parent profile. Based on the selected first information, the controller 11 loads the sheet profile included in the first information to the tray corresponding to the tray identification information included in the first information.

Further, the controller 11 registers the sheet profile in association with the tray in association with the information on the job. This makes it possible to load a sheet profile for a tray by accepting information about a job.

In addition, the controller 11 can prompt the user to set sheets to be used based on the sheet profile loaded for the tray.

### Modification Example 1

In the first modification example, the conveyance path is considered in the setting of the sheet profile and the tray.

The controller 11 (registration unit) of the image forming apparatus 10 registers at least one of the sheet profile and the tray identification information the selection of which has been accepted in association with the tray on the basis of the conveyance path along which the sheet is conveyed when the sheet profile and the tray identification information are stored in association with each other in the RAM 12.

Alternatively, the controller 11 may register the at least one of the sheet profile and the tray identification information the selection of which has been accepted, in association with the tray, based on the conveyance path along which the sheet is conveyed when the at least one of the sheet profile and the tray identification information is registered in association with the tray.

As shown in FIG. 2, in the sheet feed section 19 of the image forming apparatus 10, the sheet conveyance path varies depending on which tray is used. The conveyance path of the sheet influences the degree of bending of the sheet.

At the time when the correspondence between the sheet profile and the tray identification information is set to the RAM 12, the conveyance path has already been considered. The controller 11 registers the tray and the profile in association with each other in a state where the optimum profile is selected for each tray, based on the conveyance path corresponding to each tray. For example, when there is a demand for high-quality finishing, a tray on which sheets are less likely to bend (e.g., the sheet feed tray T3 shown in FIG. 2) is selected. Furthermore, when causing the RAM 12 to store the sheet profile and the tray identification information in association with each other, the controller 11 may determine an optimum conveyance path on the basis of the rigidity, basis weight, and the like of the sheet, and select a tray corresponding to the conveyance path.

The controller 11 registers, in the storage 13, the sheet profile and the tray identification information in association with each other using the correspondence between the sheet profile and the tray identification information stored (set) in the RAM 12 on the basis of the conveyance path.

Further, the controller 11 may cause the RAM 12 to store the correspondence relationship between the sheet profile and the tray identification information, based on the conveyance path when the sheet profile and the tray identification information are registered in association with each other. That is, there may be almost no time lag between the temporary storage in the RAM 12 and the final registration in the storage 13.

According to the first modification example, the controller 11 of the image forming apparatus 10 can set an appropriate sheet profile for a tray based on the conveyance path.

For example, the controller 11 associates and registers a pair of a sheet profile and a tray which are set in consideration of the conveyance path and stored in the RAM 12. The correspondence relationship between the sheet profile and the tray identification information stored in the RAM 12 may be set by a skilled operator in consideration of the conveyance path, or may be set by the controller 11 in consideration of the conveyance path.

### Modification Example 2

In the second modification example, when a profile is registered, information about a registrant is also registered in association with the profile.

When the image forming apparatus 10 is used by a user, the controller 11 of the image forming apparatus 10 acquires login information (e.g., user ID) of the user to identify the user. For example, the controller 11 acquires a user ID input from the operation part 15 by the user. The controller 11 may acquire the user ID from a card reader that has read the user ID recorded on an IC card owned by the user. Furthermore, the controller 11 may identify the user by face authentication, fingerprint authentication, voiceprint authentication, or the like.

The storage 13 of the image forming apparatus 10 stores, for each user, information on the user (user information). The user information includes information on proficiency and the like.

When associating at least one of the sheet profile and the tray identification information the selection has been accepted with the tray, the controller 11 (registration unit) of the image forming apparatus 10 associates and registers the information related to the registrant. The information on the registrant includes at least information on the level of proficiency of the registrant.

To select an optimum profile for a tray, a certain level of proficiency or more is required. The proficiency may be, for example, the years of engagement of the registrant in the printing technology area, the years of continuous employment in the company, or the like.

Further, the controller 11 may use the reliability of the registrant as the information on the registrant. In this case, the reliability is set to be high for a user who has little experience but has a high level of proficiency.

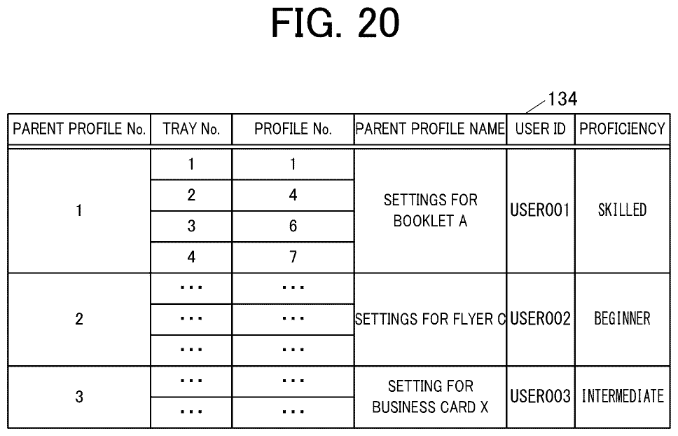

FIG. 20 shows an example of the parent profile registration table 134 stored in the storage 13. The parent profile registration table 134 includes, as parent profiles, a plurality of pairs of tray numbers and profile numbers. Furthermore, in the parent profile registration table 134, these correspondences, the parent profile names, the parent profile numbers, the user IDs of the registrants, and the levels of proficiency of the registrants are associated.

When registering the data of the parent profile (a pair of the profile and the tray), the controller 11 registers the user ID acquired as the login information and the proficiency level in association with each other. For the proficiency, the controller 11 may acquire, from the user information stored in the storage 13, the proficiency corresponding to the user (login user) who is using the image forming apparatus 10.

The controller 11 (loading unit) loads at least one of the sheet profile and the tray identification information for the tray based on the information on the registrant.

For example, among the parent profiles registered in the parent profile registration table 134, in a case where there are a plurality of pieces of data which are intended by the user (settings for booklet A or the like) and the registrants of which have different levels of proficiency, the controller 11 preferentially loads data for which the registrant has a high level of proficiency.

Further, the controller 11 may exclude a parent profile set by a registrant with a low proficiency level from the presented options. Alternatively, the controller 11 may cause a parent profile set by a registrant with a low level of proficiency to be displayed together with a warning.

Further, the controller 11 may disable specific loading processing in accordance with the proficiency level of the registrant.

According to the second modification example, the controller 11 of the image forming apparatus registers the information on the registrant in association with the sheet profile and the tray. Therefore, when the data is used later, it is possible to take measures according to the registrant. For example, when a beginner uses information set and registered by a skilled person, printing quality is improved.

The descriptions in the above embodiments and modification examples are for purposes of illustration and are not intended to limit the present invention. The detailed configuration and detailed operation of each apparatus constituting the system can also be appropriately changed without departing from the spirit of the present invention.

For example, the processes described in the embodiments and the modification examples may be appropriately combined and executed.

Furthermore, some or all of the processes described in the embodiments and modification examples may be performed by another device in the system. Some or all of the processes described in the embodiments and the modification examples may be performed by a plurality of devices in the system in cooperation with each other.

Further, in each of the above-described embodiments, the case where the data (registration data) in which at least one of the sheet profile and the tray identification information is associated with the tray is registered in the storage 13 of the image forming apparatus 10 has been described as an example. Alternatively, the registration data may be registered in the cloud server 30 or the PC 40.

Furthermore, the sheet profile is accepted (Step S11) and the data is then loaded in the profile loading processing in FIG. 5. In the automatic loading processing of FIG. 13, information on a job is accepted (Step S41) and the data is then loaded. In the manual calling processing from the controller apparatus of FIG. 15, the sheet profile and the tray identification information (parent profile) are accepted (Step S55) and the data is then loaded. In the manual loading processing from the main body screen in FIG. 18, the sheet profile and the tray identification information (parent profile) are accepted (Step S64) and the data is then loaded. Upon accepting tray identification information selected by a user, the controller 11 may load, for a tray corresponding to the tray identification information, the sheet profile associated with the tray.

The controller apparatus 20 may be a part of the image forming apparatus 10.

Furthermore, the types or the number of the various sensors included in the media sensor 50 and the position where the media sensor 50 is provided are not limited to the above-described example. The media sensor 50 may be provided at any position in the image forming apparatus 10. For example, a configuration in which the media sensor 50 is provided in each tray may be adopted. Furthermore, the media sensor 50 may be provided not only in the conveyance path in the sheet feed section 19 but also in a conveyance path in the image forming section 17 or in a conveyance path along which a sheet on which an image has been formed by the image forming section 17 is conveyed. Alternatively, the media sensor 50 may be provided outside the image forming apparatus 10 as a stand-alone device. In this case, data on the attributes of the sheet read by the media sensor 50 may be input to the image forming apparatus 10 via the communication network N or the storage medium, or may be manually input to the image forming apparatus 10 by a user.

The “information processing apparatus” according to the present invention may include functional units excluding the image forming section 17, the image reading section 18, and the sheet feed section 19 from the image forming apparatus 10.

An “information-processing system” according to the present invention may include the “information-processing apparatus” and at least one of the controller apparatus 20, the cloud server 30, and the PC 40.

The “image forming system” according to the present invention does not needs to include all the constituent elements of the image forming system 100 shown in FIG. 1. For example, the “image forming system” according to the present invention may include at least one of the controller apparatus 20, the cloud server 30, and the PC 40 in addition to the image forming apparatus 10.

1. An image processing apparatus comprising:
an association storage section that stores a sheet profile and identification information for identifying a tray to accommodate sheets in association with each other; and
a hardware processor,
wherein the hardware processor:
accepts selection of at least one of the sheet profile and the identification information; and
registers the at least one of the sheet profile and the identification information that is accepted in association with the tray.

2. The information processing apparatus according to claim 1,
wherein the hardware processor registers, based on association of the sheet profile and the identification information stored in the association storage section, the sheet profile and the identification information in association with the tray corresponding to the sheet profile and the identification information.

3. The information processing apparatus according to claim 1,
wherein the hardware processor specifies the tray corresponding to the identification information based on the at least one of the sheet profile and the identification information that is accepted, thereby setting the at least one of the sheet profile and the identification information that is accepted to the specified tray.

4. The information processing apparatus according to claim 1,
wherein a pair of the sheet profile and the identification information that is stored in the association storage section in association includes a plurality of pairs of sheet profiles and identification information pieces,
wherein the hardware processor registers at least one of the pairs of sheet profiles and identification information pieces that are accepted in association with a tray.

5. The information processing apparatus according to claim 1,
wherein upon accepting at least one of the sheet profile and the identification information registered in association with the tray, the hardware processor loads at least one of the sheet profile and the identification information for the tray.

6. The information processing apparatus according to claim 1,
wherein the hardware processor registers at least one of the sheet profile and the identification information in association with information on a job when the sheet profile and the identification information are stored in association with each other in the association storage section or when the hardware processor registers at least one of the sheet profile and the identification information in association with the tray.

7. The information processing apparatus according to claim 6,
wherein upon accepting the information on the job registered by the hardware processor, the hardware processor loads at least one of the sheet profile and the identification information for the tray.

8. The information processing apparatus according to claim 1,
wherein the sheet profile is a profile in which a sheet and an attribute of the sheet read by a sensor are associated with each other.

9. The information processing apparatus according to claim 1,
wherein the hardware processor registers at least one of the sheet profile and the identification information based on a conveyance path along which a sheet is conveyed when the sheet profile and the identification information are stored in association with each other in the association storage section or when the hardware processor registers at least one of the sheet profile and the identification information in association with the tray.

10. The information processing apparatus according to claim 1,
wherein the hardware processor registers information on a registrant in association when associating the at least one of the sheet profile and the identification information that is accepted to the tray.

11. The information processing apparatus according to claim 1,
wherein the hardware processor registers the at least one of the sheet profile and the identification information that is accepted in association with the tray after completion of a job which is executed with the sheet profile and the identification information being stored in association with each other in the association storage section.

12. The information processing apparatus according to claim 5,
wherein the hardware processor notifies that the tray is to be replenished with sheets related to the sheet profile or sheets related to the sheet profile corresponding to the identification information based on the loading by the hardware processor.

13. An information processing apparatus comprising:
an association storage section that stores first information in which a sheet profile and identification information for identifying a tray to accommodate sheets are stored in association with each other; and
a hardware processor,
wherein the hardware processor:
accepts selection of the first information stored in the association storage section; and
registers the tray corresponding to the sheet profile included in the first information in association with the sheet profile included in the first information, the first information being accepted by the hardware processor.

14. The information processing apparatus according to claim 13,
wherein the first information includes a plurality of pieces of first information,
wherein the hardware processor registers at least two or more of the plurality of pieces of first information as second information.

15. The information processing apparatus according to claim 14,
wherein upon accepting the first information registered by the hardware processor, the hardware processor loads the sheet profile included in the accepted first information for the tray corresponding to the identification information included in the accepted first information.

16. The information processing apparatus according to claim 14,
wherein upon accepting the second information registered by the hardware processor, the hardware processor loads the sheet profile included in each of the plurality of pieces of first information included in the accepted second information to the tray corresponding to the identification information included in each of the plurality of pieces of first information included in the accepted second information.

17. An information processing system comprising:
an association storage section that stores a sheet profile and identification information for identifying a tray to accommodate sheets in association with each other; and
a hardware processor,
wherein the hardware processor:
accepts selection of at least one of the sheet profile and the identification information; and
registers at least one of the sheet profile and the identification information that is accepted in association with the tray.

18. An information processing method comprising:
storing a sheet profile and identification information for identifying a tray to accommodate sheets in association with each other;
accepting selection of at least one of the sheet profile and the identification information; and
registering the at least one of the sheet profile and the identification information that is accepted in association with the tray.

19. A non-transitory storage medium storing an information processing program to be executed by a computer that controls an information processing apparatus, the program causing the computer to execute the information processing method according to claim 18.

20. An image forming system comprising:
the information processing apparatus according to claim 1; and
an image forming section that forms an image on a sheet.

21. The image forming system according to claim 20,
wherein a pair of the sheet profile and the identification information that is stored in the association storage section in association includes a plurality of pairs of sheet profiles and identification information pieces,
wherein the hardware processor registers at least one of the pairs of sheet profiles and identification information pieces that is accepted in association with a tray.

22. The image forming system according to claim 20,
wherein upon accepting at least one of the sheet profile and the identification information registered in association with the tray by the hardware processor, the hardware processor loads the at least one of the sheet profile and the identification information for the tray.

23. An image forming method in an image forming apparatus including an image forming section that forms an image on a sheet, the method comprising:
storing in an association storage section a sheet profile and identification information for identifying a tray to accommodate sheets in association with each other; and
accepting selection of at least one of the sheet profile and the identification information; and
registering the at least one of the sheet profile and the identification information that is accepted in association with the tray.

24. A non-transitory storage medium storing an image forming program to be executed by a computer that controls an image forming apparatus, the program causing the computer to execute the image forming method according to claim 23.
